(19) United States
(12) Patent Application Publication
(10) Pub. No.: US 2007/0274100 A1
(43) Pub. Date: Nov. 29, 2007

(54) Light guide plate having high brightness and uniformity of light emission and backlight module adopting same

(75) Inventors: Xing-Peng Yang, Beijing (CN); Ying-Bai Yan, Beijing (CN); Guo-Fan Jin, Beijing (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: Tsinghua University, Beijing City (CN); HON HAI Precision Industry CO., LTD., Tu-Cheng City (TW)

(21) Appl. No.: 11/543,701

(22) Filed: Oct. 5, 2006

(30) Foreign Application Priority Data
May 24, 2006 (CN) 200610060741.4

(51) Int. Cl. F21V 7/04

(52) U.S. Cl. 362/615

(57) ABSTRACT

A light guide plate includes an incident surface, an emission surface, and a bottom surface. The emission surface intersects with the incident surface and is substantially perpendicular to the incident surface. The bottom surface intersects with the incident surface and is opposite to the emission surface. The light guide plate further includes at least one light diffusing portion protruding from the incident surface. The light diffusing portion has a reflective hole located at (i.e., extending from) the bottom surface, the reflective hole protruding less than a thickness of the light guide plate. A backlight module, adopting the above-described light guide plate, further includes at least one corresponding light source positioned beside the incident surface of the light guide plate. The light source includes a luminescent surface facing a corresponding light diffusing portion of the light guide plate.

### BACKGROUND

1. Field of the Invention

The invention relates generally to light guide plates used in backlight modules of liquid crystal display devices and, more particularly, to a light guide plate having high brightness and uniformity of light emission and a backlight module adopting the same.

2. Discussion of Related Art

Liquid crystal display devices have many excellent performance characteristics, such as large-scale information display ability, easy colorization, low power consumption, long life, no pollution associated therewith, and so on. Therefore, liquid crystal display devices are used widely. A typical liquid crystal display device generally includes a backlight module, and the backlight module is used to convert linear light sources, such as cold cathode ray tubes, or point light sources, such as light emitting diodes, into area light sources having high uniformity and brightness.

Referring to FIG. 7, a typical backlight module 70 includes a plurality of light sources 710, a reflective plate 720, a light guide plate 730, a diffusion plate 740, and a prism sheet 750. The light sources 710 are positioned beside the light guide plate 730. The reflective plate 720 is positioned below the light guide plate 730, and the diffusion plate 740 and the prism sheet 750 are positioned upon the light guide plate 730, in turn.

In use, incident light beams are emitted from the light sources 710 and are transmitted into the light guide plate 730. The light guide plate 730 is used to direct the travel of the incident light beams therein and to ensure that most of the incident light beams can be emitted from a top surface of the light guide plate 730. The diffusion plate 740 is used to improve the uniformity of the light beams emitted from (i.e., transmitted out of) the light guide plate 730. The prism sheet 750 can, in turn, converge the emitted light beams. This convergence helps ensure that the emitted light beams have good uniformity and brightness. The reflective plate 720 is used to reflect some of the incident light beams that are emitted from a bottom surface of the light guide plate 720 and guide such light beams back into the light guide plate 720. This reflection enhances the utilization ratio of the incident light beams from the light sources 710 (i.e., the degree to which the strength of the light beams emitted from light source 710 is able to be maintained through the device).

However, as shown in FIG. 8, each light source 710 emits light beams over a limited predetermined range of angles, and the light beams enter the light guide plate 730 with an uneven distribution. As a result, a plurality of bright areas 82 tend to be created in some areas of the light guide plate 730 near the light sources 710, and a plurality of dark areas 84 tend to be created in other areas of the light guide plate 730, between every two light sources 710. The luminance of the dark areas 84 is less than that of the bright areas 82. That is, the luminance of the light guide plate 730 is typically not uniform.

In order to enhance the uniformity of the luminance of the light guide plate, a plurality of micro-structures can be formed at the incident surface thereof. Referring to FIG. 9, another typical backlight module 90 is shown. This backlight module 90 is particularly disclosed in JP 10-199316 and CN 1176501C, the contents of which are hereby incorporated by reference thereto. The backlight module 90 includes a light guide plate 930 and a plurality of light sources 910. The light guide plate 930 includes an incident surface 92, and the light sources 910 are located beside the incident surface 92. The light guide plate 930 further includes a plurality of sawtooth-like (i.e., sawtooth-shaped) structures 94 formed in the incident surface 92, at respective lateral positions corresponding to the light sources 910. Alternatively, as shown in FIG. 10, the light guide plate 930 further includes a plurality of cone-shaped structures 98 formed at the incident surface 92. The light beams emitted from the light sources 910 can be refracted by the corresponding sawtooth-like structures 94/cone-shaped structures 98 when are transmitted to the light guide plate 930. This refraction can enhance the uniformity of the luminance of the light guide plate 930 to a certain extent. However, some light beams, instead, are reflected by the sawtooth-like structures 94/cone-shaped structures 98 and thus can't be directed into the light guide plate 930. Thus, this reflection reduces the utilization of light energy.

Furthermore, referring to FIG. 11, a path of a light beam transmitted through the sawtooth-like structures 94 of the light guide plate 930 of FIG. 9 is shown. As shown in FIG. 11, a top angle of the sawtooth-like structures 94 is labeled as α. According to the formula of Fresnel and geometrical relation, a refraction angle β of the light beam after transmission through the sawtooth-like structures 94 of the light guide plate 930 is expressed as follow:

$$β = 90 - \frac{α}{2} - arc sin ( \frac{sin ( 90 - \frac{α}{2} )}{n} )$$

(wherein n is the refractive index of the material of the light guide plate 730). It can be concluded that the refraction angle β is limited. For example, if the light guide plate 930 is made of PMMA, the refraction angle β is less than 50 degrees. Thus, the sawtooth-like structures 94/cone-shaped structures 98 can't avoid the dark areas completely.

Referring to FIG. 12, still another typical planar light source unit 60 is shown. This planar light source unit 60 is particularly disclosed in U.S. Pat. No. 6,139,163, the contents of which are hereby incorporated by reference thereto. The planar light source unit 60 includes an LED 610 and a light leading plate 630. The light leading plate 630 includes a light discharge surface 632, a light diffusing plane 634, and a V-shaped reflecting side 636. The V-shaped reflecting side 636 includes an incidence portion 638 formed at a center thereof and a plurality of reflection recesses 640 formed at opposite sides thereof. Each of the incidence portions 638 and the reflection recesses 640, in the illustrated embodiment, has a semicircular cylindrical shape. The LED 610 is located at the incidence portion 638 of the light leading plate 630. Furthermore, the light leading plate 630 has a central through hole 642 formed at a position opposite to the LED 610.

The light beams emitted from the LED 610 can be reflected by the central through hole 642 and the reflection recesses 640, in turn, when the light beams are transmitted to the light leading plate 630. This reflection can enhance the uniformity of the luminance of the light leading plate 630 to a certain extent. However, as the central through hole 642 extends to the light discharge surface 632, all or nearly all of the light beams within the lateral range of the central through hole 642 are reflected thereby. Thus, the area within its lateral range would tend to be darker than other areas. Thus, the dark areas still can't be avoided completely in the light leading plate 630.

What is needed, therefore, is a light guide plate having high brightness, uniformity of light emission, and utilization of light energy.

What is also needed is a backlight module adopting the above-described light guide plate.

### SUMMARY

In one embodiment, a light guide plate includes an incident surface, an emission surface, and a bottom surface. The emission surface intersects with the incident surface and is substantially perpendicular to the incident surface. The bottom surface intersects with the incident surface and is opposite to the emission surface. The light guide plate further includes at least one light diffusing portion protruding from the incident surface thereof. The light diffusing portion employs a reflective hole located at/in the bottom surface of the light guide plate.

In another embodiment, a backlight module adopts the above-described light guide plate and further includes at least one corresponding light source positioned beside/across from the incident surface of the light guide plate. The light source includes a luminescent surface facing the corresponding light diffusing portion of the light guide plate.

Other advantages and novel features of the present light guide plate and the backlight module adopting the same will become more apparent from the following detailed description of preferred embodiments when taken in conjunction with the accompanying drawings.

### BRIEF DESCRIPTION OF THE DRAWINGS

Many aspects of the present light guide plate and the backlight module adopting the same can be better understood with reference to the following drawings. The components in the drawings are not necessarily to scale, the emphasis instead being placed upon clearly illustrating the principles of the present light guide plate and the backlight module adopting the same.

FIG. 1 is an isometric view of a backlight module, in accordance with a first embodiment of the present device;

FIG. 2 is a schematic, top view of FIG. 1, showing paths of light beams transmitted therein;

FIG. 3 is a schematic, enlarged view of the portion III in FIG. 2;

FIG. 4 is a schematic, top view of a backlight module, in accordance with a second embodiment of the present device, showing paths of light beams transmitted therein;

FIG. 5 is a schematic, enlarged view of the portion V in FIG. 4;

FIG. 6 is a schematic, top view of a backlight module, in accordance with a third embodiment of the present device, showing paths of light beams transmitted therein;

FIG. 7 is an isometric, exploded view of a first conventional backlight module;

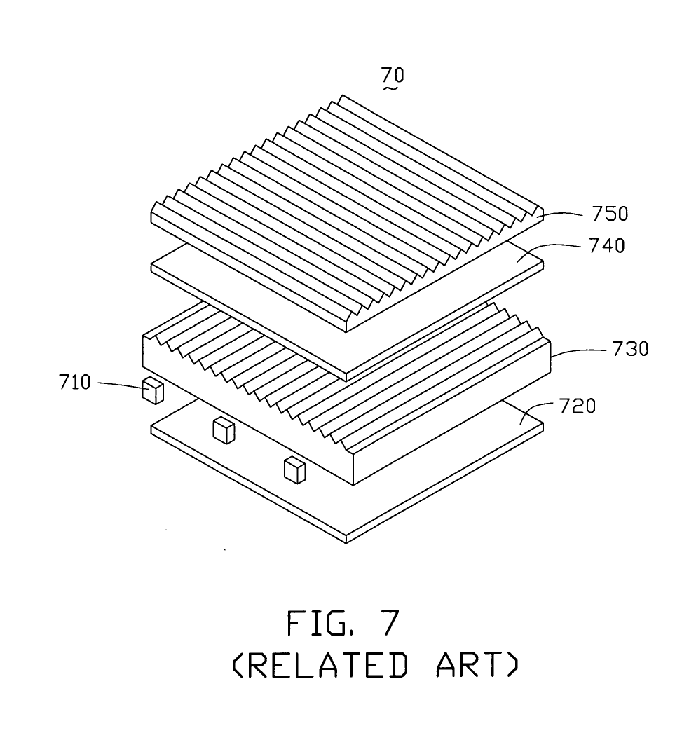

FIG. 8 is a schematic view of the first conventional backlight module of FIG. 7, showing a plurality of bright areas and dark areas formed therein;

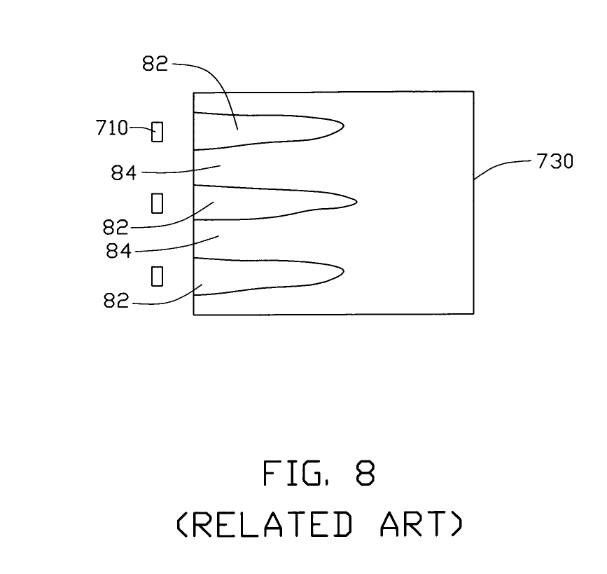

FIG. 9 is an isometric view of a second conventional backlight module, showing a plurality of micro-structures formed on an incident surface of a light guide plate thereof;

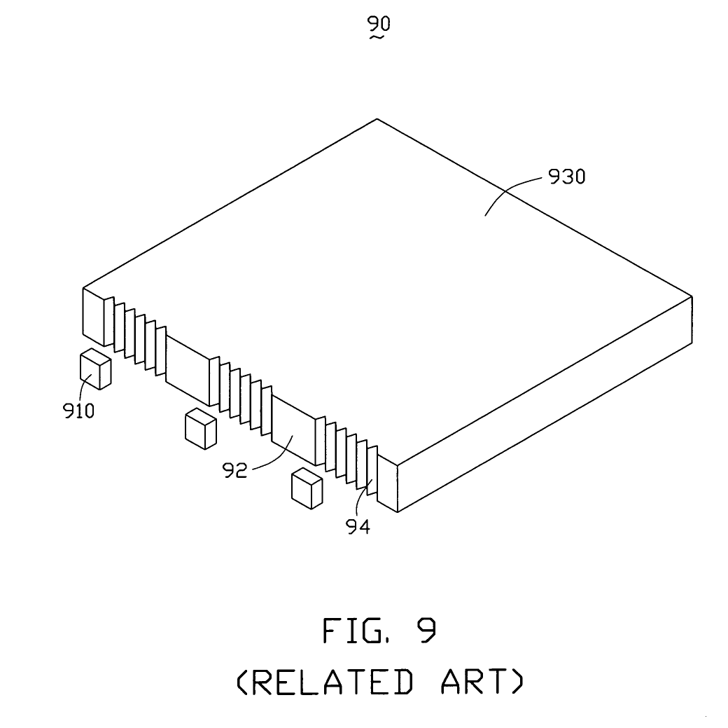

FIG. 10 is an isometric view of a third conventional backlight module, showing a plurality of micro-structures formed on an incident surface of a light guide plate thereof;

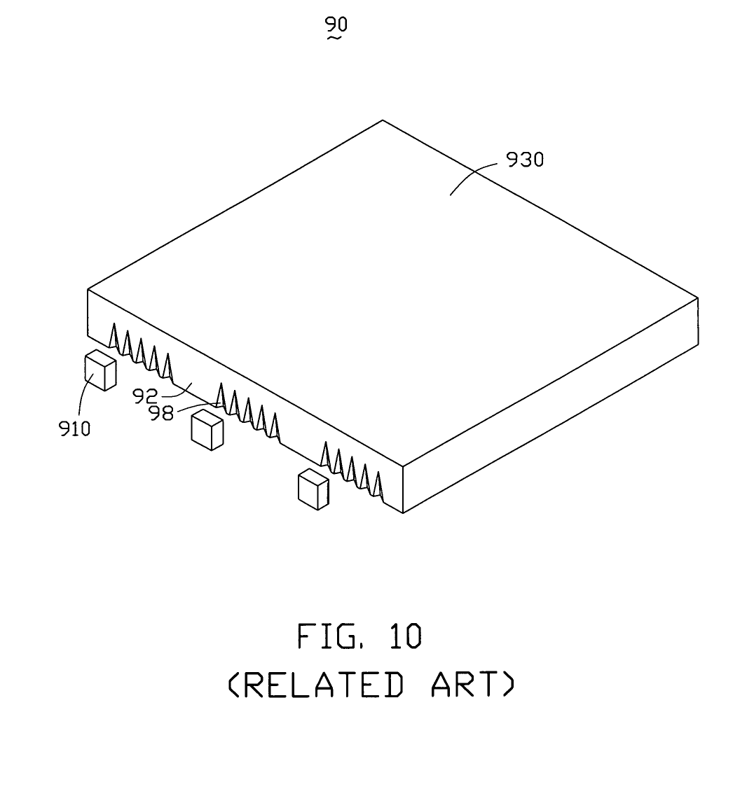

FIG. 11 is a schematic view of a path of a light beam transmitted through the micro-structures of the light guide plate of FIG. 9; and

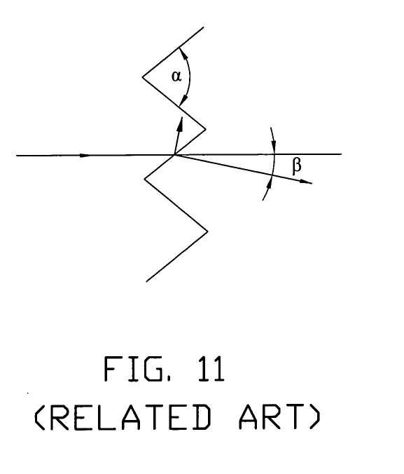

FIG. 12 is an isometric view of a fourth conventional backlight module.

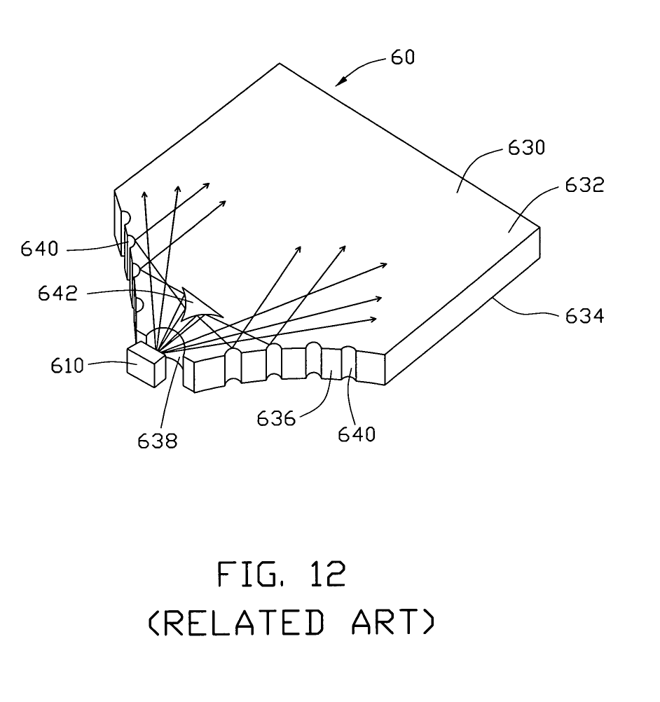

Corresponding reference characters indicate corresponding parts throughout the several views. The exemplifications set out herein illustrate at least one preferred embodiment of the present light guide plate and the backlight module adopting the same, in one form, and such exemplifications are not to be construed as limiting the scope of the invention in any manner.

### DETAILED DESCRIPTION OF PREFERRED EMBODIMENTS

Reference will now be made to the drawings to describe embodiments of the present light guide plate and the backlight module adopting the same, in detail.

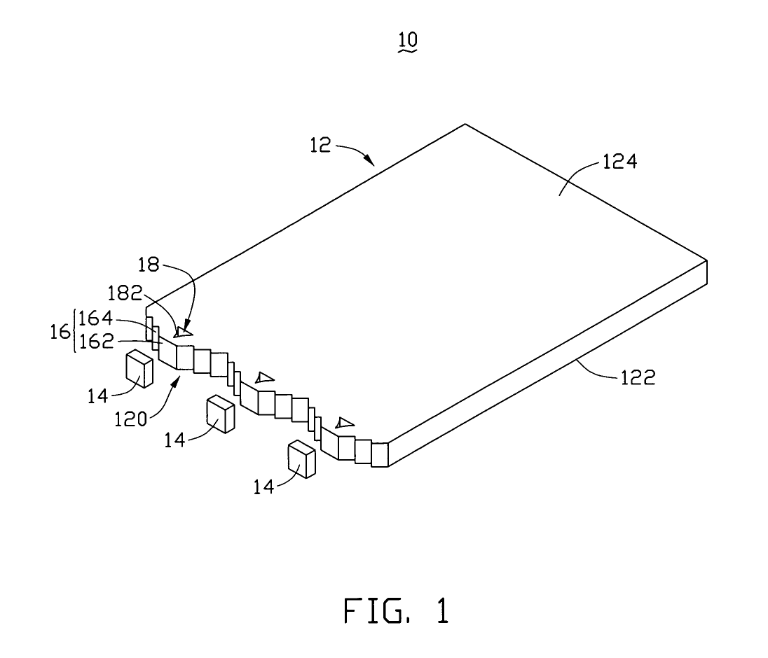

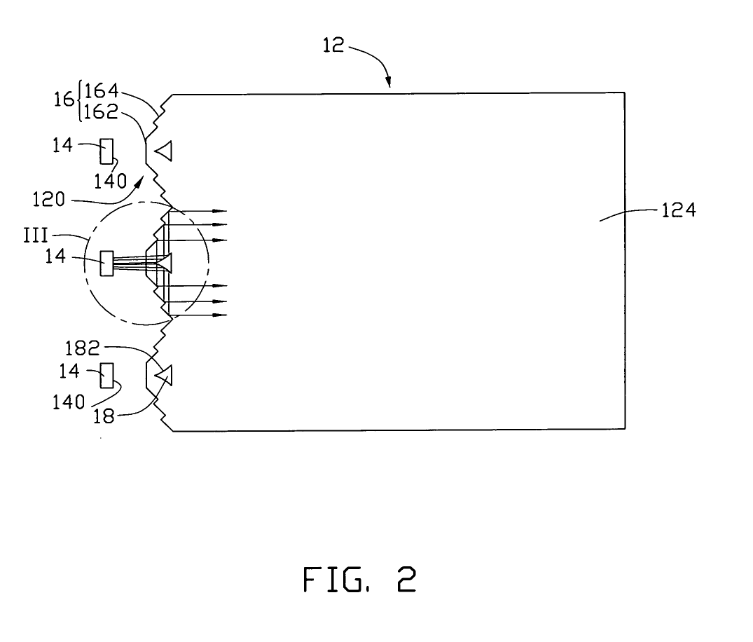

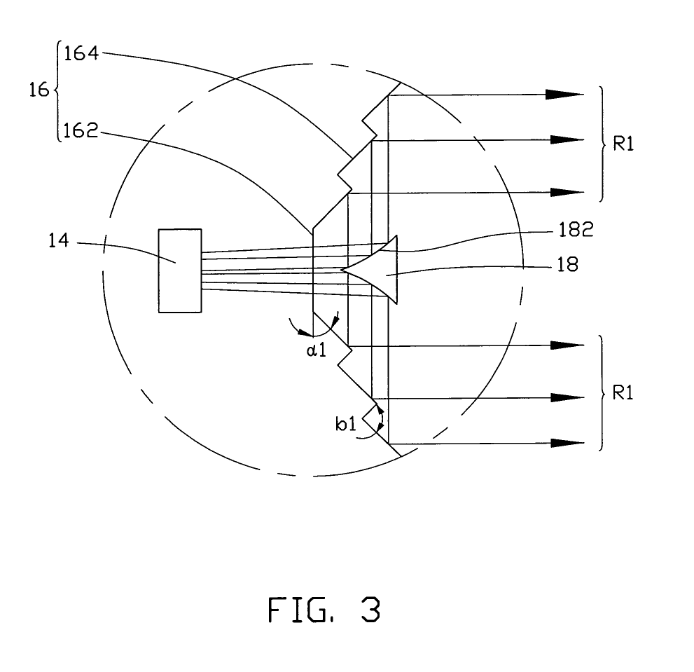

FIGS. 1-3 show a backlight module 10, in accordance with a first embodiment of the present device. As shown in FIGS. 1-3, the backlight module 10 includes a light guide plate 12 and a plurality of light sources 14 located beside the light guide plate 12. The light guide plate 10 can be flat or wedged in shape. The light guide plate 10 can be, beneficially, made of polycarbon (PC), polymethyl methacrylate (PMMA), polyethylene, or glass. The light guide plate 12 includes an incident surface 120, an emission surface 122, and a bottom surface 124. The emission surface 122 intersects with the incident surface 120 and is substantially perpendicular to the incident surface 120. The bottom surface 124 intersects with the incident surface 120 and is opposite to the emission surface 122. The light sources 14 are particularly positioned adjacent the incident surface 120.

Furthermore, the light guide plate 12 includes a plurality of light diffusing portions 16 protruding from the incident surface 120. Each light diffusing portion 16 includes a pair of symmetrical light reflective surfaces 164 and a light transmissive surface 162 positioned between the symmetrical light reflective surfaces 164. An included angle between the light transmissive surface 162 and each light reflective surface 164 is labeled as “a1”. The value of the angle a1 is about in the range from 30 degrees to 60 degrees. Preferably, the value of the angle a1 is about 45 degrees. Each light reflective surface 164 is advantageously selected from the group consisting of stair-shaped surfaces, sawtooth-shaped surfaces, free-curved surfaces, and truncated-cone-shaped surfaces. In the first embodiment, each reflective surface 164 is a stair-shaped surface. A top angle of the stair-shaped reflective surface 164 is labeled as “b1”.

Furthermore, each light diffusing portion 16 includes a reflective hole 18 located at the bottom surface 124. A sectional shape of the reflective hole 18 is usefully selected from the group consisting of triangular, round/arcuate, square, rhombic, elliptical, and pyramidal. In the first embodiment, a section of the reflective hole 18 is a triangle. The reflective hole 18 includes a pair of symmetrical side surfaces 182 corresponding, respectively, to the reflective surfaces 164 of the light diffusing portion 16. Each side surface 182 of the reflective hole 18 is, advantageously, selected from the group consisting of flat surfaces, paraboloids, and compound hyperboloids. In the first embodiment, each side surface 182 of the reflective hole 18 is a paraboloid. A depth of the reflective hole 18 is less than a thickness of the light guide plate 12 (i.e., the reflective hole 18 is not a through hole and does not extend to/intersect the emission surface 122). It is structurally important that the reflective hole 18 does not extend to the emission surface 122, thereby allowing a portion of the light within the lateral range of the reflective hole 18 to not get reflected thereby. By not reflecting all or nearly all the light within its lateral range, it is possible to avoid a darkened area in the lateral region beyond the reflective hole 18. In the first embodiment, the depth of the reflective hole 18 is about a half of the thickness of the light guide plate 12.

The side surfaces 182 of the reflective holes 18 and the light reflective surfaces 164 of the light diffusing portions 16 can totally or nearly totally reflect the light beams transmitted thereon. Furthermore, the side surfaces 182 of the reflective holes 18 and the light reflective surfaces 164 of the light diffusing portions 16 can have reflective metal films, such as silver or aluminum films, coated thereon or a reflective backing mounted adjacent thereto to reflect the light beams and to further ensure essentially full utilization of the light beams entering the light guide plate 12.

Each light source 14 is, usefully, a light emitting diode (LED), and each is respectively positioned corresponding to a given light diffusing portion 16. The light source 14 includes a luminescent surface 140 facing the light transmissive surface 162 of the corresponding light diffusing portion 16. The light diffusing portions 16 are used to lead/guide light beams emitted by the light sources 14 into the light guide plate 12. Detailed, the light transmissive surfaces 162 of the light diffusing portions 16 are used to more uniformly distribute the light beams throughout the light guide plate 12. The value of the top angle b1 of the stair-like reflective surfaces 164 is decided by the value of the angle a1 and the side surfaces 182 of the reflective holes 18. The value of the top angle b1 of the stair-like reflective surfaces 164 should ensure that some incident light beams R1 that are near the bottom surface 124 of the light guide plate 12 can be reflected by the side surfaces 182 of the reflective holes 18 and then transmitted to the light reflective surfaces 164 of the light diffusing portions 16, along a direction parallel to the incident surface 120 of the light guide plate 12. Then, the light reflective surfaces 164 of the light diffusing portions 16 are used to reflect the light beams R1 into the light guide plate 12. Preferably, the value of the top angle b1 is about 60 degrees.

In use, the light sources 14 emit the light beams via the luminescent surface 140 thereof. The light beams are led/guided into the light guide plate 12 through the light transmissive surfaces 162 of the light diffusing portions 16. Because the reflective holes 18 of the light diffusing portions 16 are located at the bottom surface 124 of the light guide plate 12, and the thickness thereof is less than that of the light guide plate 12, some incident light beams near the emission surface 122 of the light guide plate 12 would not be reflected by the side surfaces 182 of the reflective hole 18, instead being transmitted into the light guide plate 12 directly. Meanwhile, the other incident light beams R1, near the bottom surface 124, would be reflected by the side surfaces 182 of the reflective holes 18 of the diffusing portions 16 and then would be transmitted to the light reflective surfaces 164 along a direction parallel to the incident surface 120 of the light guide plate 12. Then, the light beams R1 would be reflected by the light reflective surfaces 164 of the light diffusing portions 16 to the areas between every two light sources 14.

That is, the light beams R1 can be transferred from the areas near the light sources 14 to the areas between every two light sources 14 via double total reflections. Thus, the luminance of the areas near the light sources 14 is equal to/similar to that of the areas between every two light sources 14. That is, the luminance of the light guide plate 12 is uniform and bright. Therefore, the light guide plate can generally avoid the dark areas existing in the conventional light guide plate completely or at least nearly so. Furthermore, essentially all the light beams emitted by the light sources 14 can be guided into the light guide plate 12, thus the light energy can be utilized very efficiently. Therefore, the light guide plate 12 has a high utilization of the light energy (i.e., the degree to which the strength of the light beams emitted from light source 502 is able to be maintained through the device).

It can be understood that the depth of the reflective hole 18 can be chosen according to the actual needs to adjust the number of the light beams R1. Furthermore, the value of the top angles b1 of the stair-like reflective surfaces 164, the value of the included angles a1 between the light transmissive surfaces 162 and the light reflective surfaces 164, and the radian of the side surfaces 182 of the reflective holes 18 can each be chosen to adjust the spots/positions at which the light beams R1 are reflected.

The backlight module 10 can further include a plurality of micro-structures (not shown) formed on the emission surface 122 and/or the bottom surface 124 of the light guide plate 12. The micro-structures are used to control the emission direction of the light beams and are advantageously selected from the group consisting of recesses, convex or concave columns, semi-spheres, pyramids, and pyramids without tips (i.e., truncated pyramids). Still furthermore, the backlight module 10, advantageously, includes a reflective plate (not shown) located below the bottom surface 124 of the light guide plate 12, a diffusion plate (not shown) positioned above the emission surface 122 of the light guide plate 12, and a prism sheet (not shown) above the diffusion plate. The reflective plate is used to reflect some of the incident light beams that are emitted from the bottom surface 124 of the light guide plate 12 and, thereby, guide such light beams back into the light guide plate 12. The diffusion plate is used to improve the uniformity of the light beams emitted from (i.e., transmitted out of) the light guide plate 12. The prism sheet is used to converge the emitted light beams.

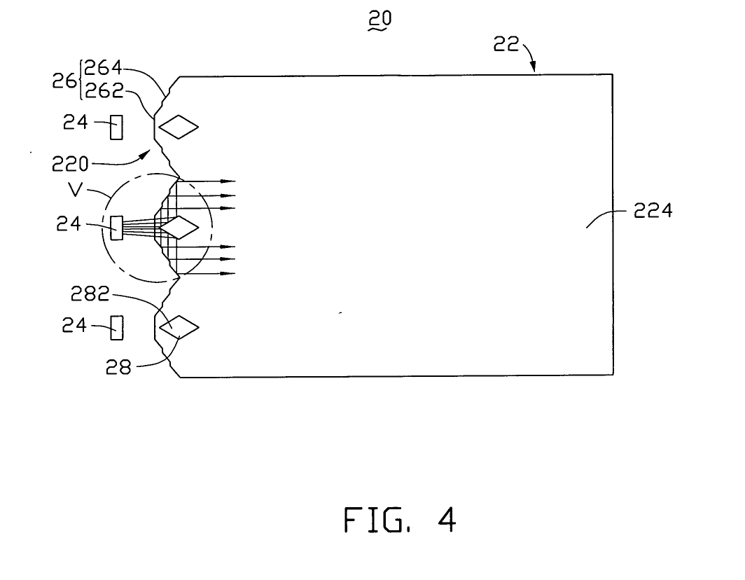

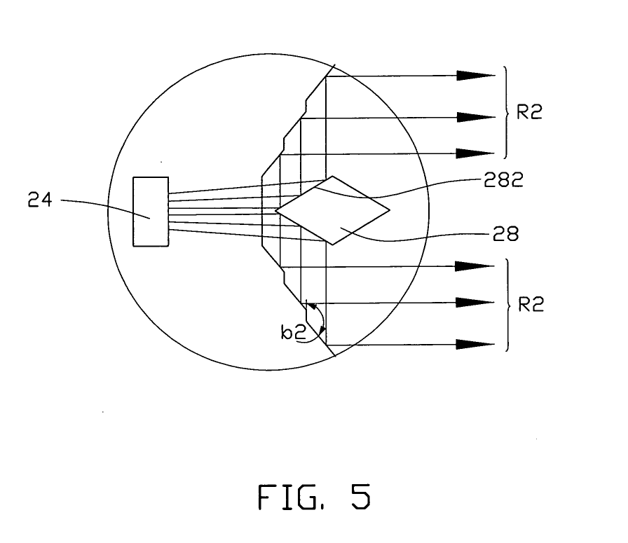

Referring to FIGS. 4 and 5, a backlight module 20, in accordance with a second embodiment of the present device, is shown. The backlight module 20 is similar to the backlight module 10 except that a section of each reflective hole 28 is a rhombus, and the side surfaces 282 thereof are flat surfaces. The value of the top angle b2 of the stair-like reflective surfaces 264 is about 120 degrees. The backlight module 20 includes a light guide plate 22 and a plurality of light sources 24 located beside/adjacent the light guide plate 12. Furthermore, the light guide plate 22 includes a plurality of light diffusing portions 26 protruding from an incident surface 220 of the light guide plate 22 and respectively facing corresponding light sources 24. The light diffusing portions 26 are used to guide the light beams emitted from the light source 24 into the body of the light guide plate 22. Each light diffusing portion 26 includes a pair of symmetrical stair-shaped light reflective surfaces 264 and a light transmissive surface 262 positioned between the symmetrical stair-shaped light reflective surfaces 264. Furthermore, each light diffusing portion 26 includes a reflective hole 28 located at a bottom surface 224 of the light guide plate 22. Each reflective hole 28 includes a pair of symmetrical side surfaces 282 respectively corresponding to the reflective surfaces 264 of the light diffusing portion 26.

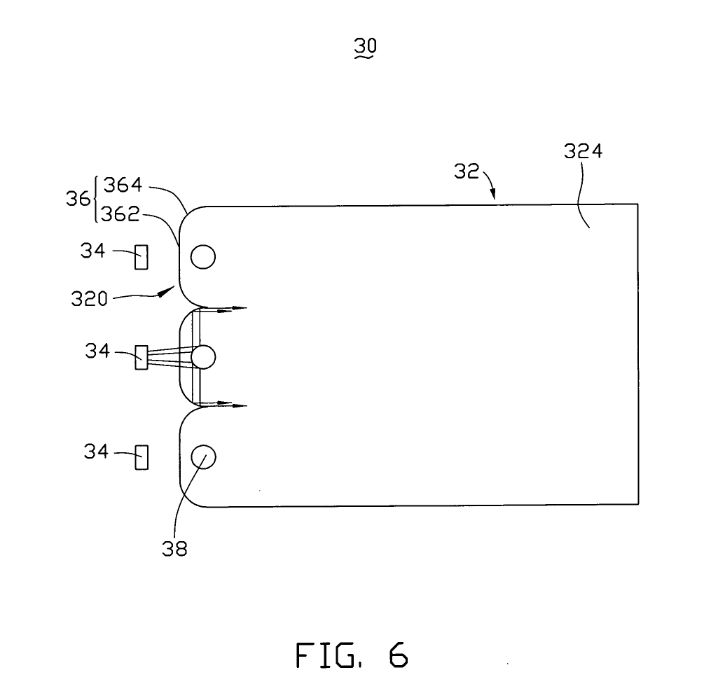

Referring to FIG. 6, a backlight module 30, in accordance with a third embodiment of the present device, is shown. The backlight module 30 is similar to the backlight module 10 except that a section of each reflective hole 38 is round or even circular, and the light reflective surfaces 364 are free-curved surfaces. The term “free-curved” is particularly intended to include curvatures that may vary over different portions of a given surface. The backlight module 30 includes a light guide plate 32 and a plurality of light sources 34 located adjacent the light guide plate 32. Furthermore, the light guide plate 32 includes a plurality of light diffusing portions 36 protruding from an incident surface 320 of the light guide plate 32 and respectively facing the light sources 34. The light diffusing portions 36 are used to guide the light beams emitted from the light source 34 into the body of the light guide plate 32. Each light diffusing portion 36 includes a pair of symmetrical light reflective surfaces 364 and a light transmissive surface 362 positioned between the symmetrical light reflective surfaces 364. Furthermore, each light diffusing portion 36 includes a reflective hole 38 located at a bottom surface 324 of the light guide plate 32.

It can be understood that the section of the reflective holes, the shape of the side surfaces of the reflective holes, and the structure of the light reflective surfaces of the light diffusing portions can be chosen according to the actual needs. The combination of the section of the reflective holes, the shape of the side surfaces of the reflective holes, and the structure of the light reflective surfaces of the light diffusing portions should ensure that some incident light beams near the bottom surface of the light guide plate can be reflected by the side surfaces of a given reflective hole, then transmitted to the light reflective surfaces along a direction parallel to the incident surface of the light guide plate and then reflected into the light guide plate by the light reflective surfaces of the light diffusing portions.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

We claim:

1. A light guide plate comprising:
an incident surface having at least one light diffusing portion protruding therefrom;
an emission surface intersecting with the incident surface; and
a bottom surface intersecting with the incident surface and opposite to the emission surface, the light diffusing portion having a reflective hole located at the bottom surface, the reflective hole extending less than a thickness of the light guide plate.

2. The light guide plate as claimed in claim 1, wherein the light diffusing portion comprises a pair of light reflective surfaces and a light transmissive surface positioned between the light reflective surfaces.

3. The light guide plate as claimed in claim 2, wherein each light reflective surface is a free-curved surface.

4. The light guide plate as claimed in claim 2, wherein each light reflective surface is selected from the group consisting of stair-shaped surfaces, sawtooth-shaped surfaces and truncated-cone-shaped surfaces.

5. The light guide plate as claimed in claim 1, wherein a shape of a section of the reflective hole is selected from the group consisting of triangular, round, square, rhombic, elliptical, and pyramidal.

6. The light guide plate as claimed in claim 5, wherein the reflective hole comprises a pair of side surfaces respectively corresponding to the reflective surfaces of the light diffusing portions.

7. The light guide plate as claimed in claim 6, wherein each side surface of the reflective hole is selected from the group consisting of flat surfaces, paraboloids, and compound hyperboloids.

8. The light guide plate as claimed in claim 1, wherein the emission surface is substantially perpendicular to the incident surface.

9. A backlight module comprising:
a light guide plate comprising:
an incident surface having at least one light diffusing portion protruding therefrom;
an emission surface intersecting with the incident surface; and
a bottom surface intersecting with the incident surface and opposite to the emission surface, the light diffusing portion having a reflective hole located at the bottom surface, the reflective hole extending less than a thickness of the light guide plate; and
at least one light source located adjacent the incident surface of the light guide plate.

10. The backlight module as claimed in claim 9, wherein the light diffusing portion comprises a pair of light reflective surfaces and a light transmissive surface positioned between the light reflective surfaces.

11. The backlight module as claimed in claim 10, wherein each light reflective surface is a free-curved surface.

12. The backlight module as claimed in claim 10, wherein each light reflective surface is selected from the group consisting of stair-shaped surfaces, sawtooth-shaped surfaces and truncated-cone-shaped surfaces.

13. The backlight module as claimed in claim 9, wherein a shape of a section of the reflective hole is selected from the group consisting of triangular, round, square, rhombic, elliptical, and pyramidal.

14. The backlight module as claimed in claim 13, wherein the reflective hole comprises a pair of side surfaces respectively corresponding to the reflective surfaces of the light diffusing portions.

15. The backlight module as claimed in claim 14, wherein each side surface of the reflective hole is selected from the group consisting of flat surfaces, paraboloids, and compound hyperboloids.

16. The light guide plate as claimed in claim 9, wherein the emission surface is substantially perpendicular to the incident surface.

17. The light guide plate as claimed in claim 9, wherein the light source includes a luminescent surface facing a corresponding light diffusing portion of the light guide plate.
